(19) United States
(12) Patent Application Publication
(10) Pub. No.: US 2025/0231838 A1
(43) Pub. Date: Jul. 17, 2025

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: XIAOLI WANG, Tokyo (JP)

(21) Appl. No.: 18/985,323

(22) Filed: Dec. 18, 2024

(30) Foreign Application Priority Data
Jan. 16, 2024 (JP) 2024-004657

(51) Int. Cl. G06F 11/14; G06F 9/4401

(52) U.S. Cl. CPC G06F 11/142; G06F 9/4406; G06F 2201/805

(57) ABSTRACT

An information processing apparatus includes one or more units, wherein the one or more units include a unit controller, the unit controller includes a first sub-system and a second sub-system, and in a case where the first sub-system cannot communicate with the second sub-system when the information processing apparatus is booted, the first sub-system overwrites, with a recovery program, a program of the second sub-system stored in a memory in which the program of the second sub-system is stored.

### BACKGROUND OF THE INVENTION

### Field of the Invention

The present invention relates to an information processing apparatus, a method for controlling the information processing apparatus, and a storage medium.

### Description of the Related Art

In general, an electronic equipment system such as a printer system often includes a controller that controls the entire system and a plurality of peripheral devices. In a system with a relatively simple structure or a system with a small variation in the configuration of peripheral devices, the configuration hardware of the controller is often constant, and the software for operating the controller also has a small variation.

Since such a system has a common controller, cost reduction by mass production is expected, but it is difficult to customize the system, and the development cost increases. Such a system is called a fixed configuration system. Details of the fixed configuration system will be described later.

On the other hand, there is a system in which functions of an electronic equipment system are modularized.

For example, there is a printer system in which functions such as a printer, fixing, and sheet conveyance are modularized. By rearranging modules of respective functions in accordance with needs, customization is easy and the development cost decreases. In such a system, a board mounted with a field-programmable gate array (FPGA) may be used as a controller of the module.

The FPGA is a device in which a gate (logic circuit) that a designer can program a configuration of a logic circuit in a field (site) is integrated. In the FPGA, a circuit structure can be changed by a program, and an optimal, efficient circuit can be configured in accordance with the function of the module. It is characterized in that the designer can change the processing content of the FPGA.

Such a system is called a variable configuration system in contrast to the fixed configuration system. In the variable configuration system, since the software of the controller can be changed in accordance with various peripheral devices, the system can be easily changed and expanded as compared with the fixed configuration system. Therefore, there is an advantage that the development cost of the system is lower than that of the fixed structure system. Details of the variable configuration system will be described later.

Japanese Patent Laid-Open No. 2022-157063 proposes an information processing apparatus that performs falsification detection and recovery by verification of a plurality of pieces of partial software booted in stages such as a BIOS and other software. In the above related art, a control program for implementing the BIOS is stored in a flash ROM, and a copy of the control program for implementing the BIOS is stored in a ROM. Then, a BIOS verification unit verifies the BIOS stored in the flash ROM, and when the verification is not successful, the BIOS verification unit executes a recovery process of the BIOS stored in the flash ROM by copy of the BIOS stored in the ROM, and gives a BIOS boot instruction to the CPU.

Japanese Patent Laid-Open No. 2005-235074 proposes a system including a configuration module and an FPGA, in which the configuration module configures (programs) the FPGA when power is turned on, and detects a software error of the FPGA by an error correction code. When detecting a software error, the technique of Japanese Patent Laid-Open No. 2005-235074 can avoid the software error without stopping the operation by reconfiguring a position where the software error occurs in the FPGA.

Japanese Patent Laid-Open No. 2012-174228 proposes a system including, in an FPGA, two CPUs, a processing program, and a falsification detection program for detecting falsification of the processing program, and the system executes the processing program and the falsification detection program by separate CPUs in the FPGA. The technique of Japanese Patent Laid-Open No. 2012-174228 can prevent the falsification detection program from being falsified by including the falsification detection program in the FPGA.

However, the technique of Japanese Patent Laid-Open No. 2005-235074 described above has a problem of not being suitable for verification and recovery of changeable firmware of the FPGA because it is necessary to store a copy of software in the ROM in advance. The techniques of Japanese Patent Laid-Open No. 2005-235074 and Japanese Patent Laid-Open No. 2012-174228 described above have a problem of not being able to handle a change of a program of the FPGA accompanying a change of hardware.

### SUMMARY OF THE INVENTION

The present invention enables realization of an information processing apparatus suitable for verification and recovery of an FPGA by performing recovery of firmware of the FPGA by minimum configuration data having a minimum function of firmware of the FPGA at the time of an error of the FPGA.

One aspect of the present invention provides an information processing apparatus including one or more units, wherein the one or more units include a unit controller, the unit controller includes a first sub-system and a second sub-system, and in a case where the first sub-system cannot communicate with the second sub-system when the information processing apparatus is booted, the first sub-system overwrites, with a recovery program, a program of the second sub-system stored in a memory in which the program of the second sub-system is stored.

Another aspect of the present invention provides an information processing apparatus including one or more units, wherein the one or more units include a unit controller, the unit controller includes a first sub-system and a second sub-system, when the information processing apparatus is booted, the second sub-system collects configuration information of the second sub-system and transfers the configuration information to the first sub-system, and the first sub-system acquires a program based on the configuration information from a server, and overwrites, with the program, a program of the second sub-system stored in a memory in which the program of the second sub-system is stored.

Still another aspect of the present invention provides a method for controlling an information processing apparatus including one or more units each including a unit controller including a first sub-system and a second sub-system, wherein in a case where the first sub-system cannot communicate with the second sub-system when the information processing apparatus is booted, the first sub-system overwrites, with a recovery program, a program of the second sub-system stored in a memory in which the program of the second sub-system is stored.

Yet still another aspect of the present invention provides a non-transitory computer-readable storage medium, the storage medium storing a program for causing a computer to execute each step of a method for controlling an information processing apparatus including one or more units each including a unit controller including a first sub-system and a second sub-system, the method wherein in a case where the first sub-system cannot communicate with the second sub-system when the information processing apparatus is booted, the first sub-system overwrites, with a recovery program, a program of the second sub-system stored in a memory in which the program of the second sub-system is stored.

Further features of the present invention will become apparent from the following description of exemplary embodiments (with reference to the attached drawings).

### BRIEF DESCRIPTION OF THE DRAWINGS

FIG. 1 is a block diagram illustrating a configuration of an image forming apparatus of a general fixed configuration system.

FIG. 2 is a block diagram illustrating a hardware configuration of a controller of the image forming apparatus of the general fixed configuration system.

FIG. 3 is a block diagram of a variable configuration system of one embodiment.

FIG. 4 is a view illustrating a controller of the variable configuration system of one embodiment.

FIG. 5 is a boot flow diagram of the variable configuration system of one embodiment.

FIG. 6 is a case of an error of the variable configuration system of one embodiment.

FIG. 7 is a recovery flow diagram of the variable configuration system of one embodiment.

FIG. 8 is a recovery flow diagram of the variable configuration system of one embodiment.

FIG. 9 is a comparison diagram of a recovery program and an operation program of one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the following embodiment, an information processing apparatus according to the present invention will be described with an image forming apparatus as an example, but the information processing apparatus is not limited to the image forming apparatus and may be a general information processing apparatus.

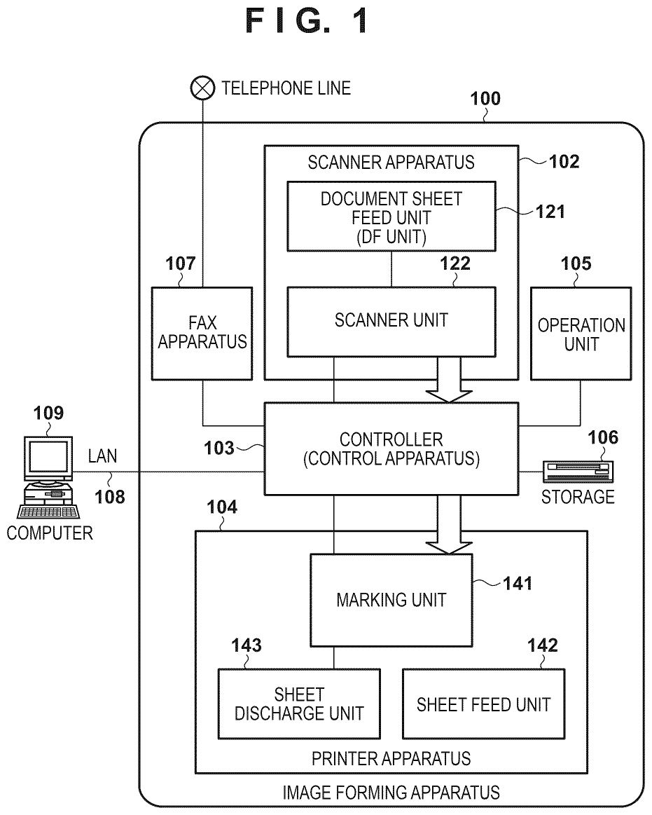

A hardware configuration of a general image forming apparatus 101 will be described with reference to FIG. 1.

The image forming apparatus 101 is configured to include a scanner apparatus 102, a printer apparatus 104, an operation unit 105, a storage 106, a FAX apparatus 107, and a controller 103.

The scanner apparatus 102 optically reads an image of a document and converts the image into digital image data. The printer apparatus 104 forms (prints) an image on a paper medium (sheet) based on the digital image data. The operation unit 105 receives a user's operation on this image forming apparatus 101 and presents various types of information to the user. Note that this operation unit 105 may include a display unit having a touch panel function. The storage 106 is a large-capacity storage apparatus that stores digital image data, control programs, and the like. This storage 106 includes, for example, a hard disk drive (HDD) or an SD memory. The FAX apparatus 107 transmits and receives digital image data by facsimile via a telephone line or the like.

By being connected to the above-described units and controlling the units, the controller (control unit) 103 can execute various jobs on the image forming apparatus 101. The image forming apparatus 101 can transmit and receive digital image data and the like to and from a computer 109 via a LAN 108. The computer 109 can issue a job to the image forming apparatus 101, instruct equipment, and the like. The LAN 108 is not limited to a wired LAN, and may be a wireless LAN connected by a wireless router.

The scanner apparatus 102 includes a document sheet feed unit 121 that can load a document bundle and automatically feed sheets of the document, and a scanner unit 122 that optically scans the document and converts the document into digital image data, and the converted digital image data is transmitted to the controller 103. The printer apparatus 104 includes a sheet feed unit 142 that can feed sheets one by one from a sheet bundle, a marking unit 141 for printing image data on fed sheets, and a sheet discharge unit 143 for discharging printed sheets.

The computer 109 issues an instruction to the controller via the LAN 108 to cause the controller 103 to execute a job. In this embodiment, the computer 109 transmits a power off instruction to the controller 103, whereby the controller 103 can control a power off sequence of the image forming apparatus 101.

This image forming apparatus 101 can execute various jobs. Examples of these jobs will be described below.

### Copy Function

Image data of an image of a document read by the scanner apparatus 102 is recorded in the storage 106, and printing is performed using the printer apparatus 104.

### Image Transmission Function

Image data obtained from the scanner apparatus 102 is transmitted to the computer 109 via the LAN 108.

### Image Saving Function

An image read from the scanner apparatus 102 is stored in the storage 106, and image transmission and printing are performed as necessary.

### Image Print Function

For example, a page description language transmitted from the computer 109 is analyzed and printed by the printer apparatus 104.

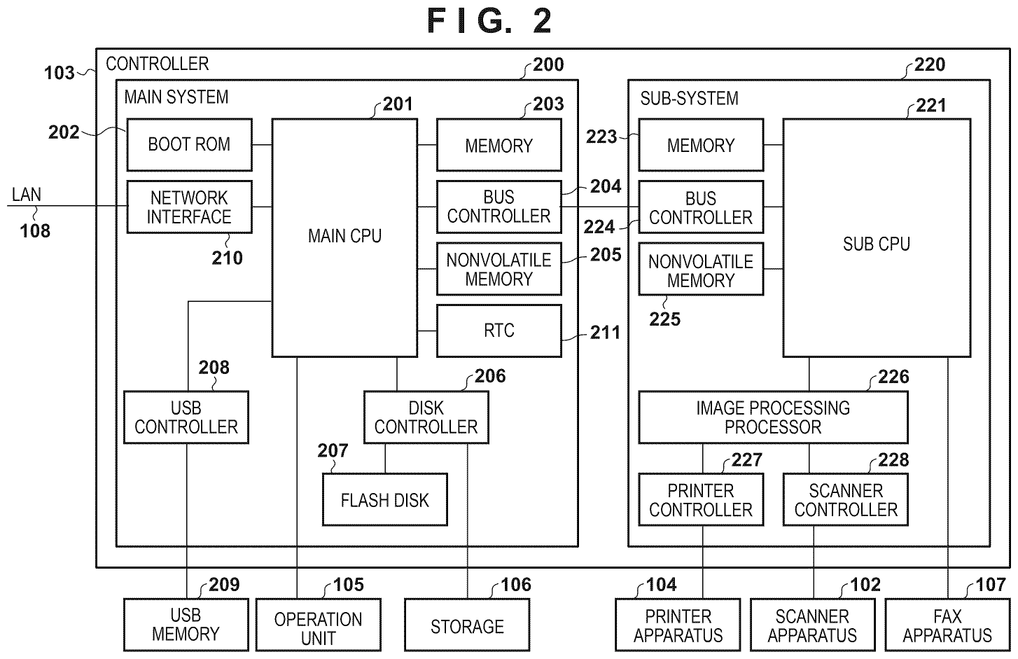

A hardware configuration of the controller 103 that is general of the image forming apparatus 101 of FIG. 1 will be described with reference to FIG. 2.

The controller 103 includes a main system 200 and a sub-system 220. The main system 200 is what is called a general-purpose CPU system. The main system 200 includes a CPU 201, a boot ROM 202, a memory 203, a bus controller 204, a nonvolatile memory 205, a disk controller 206, a flash disk 207, a USB controller 208, a network interface 210, and an RTC 211.

The CPU 201 controls the entire main system. The boot ROM 202 stores a boot program. The memory 203 is used as a work memory by the main CPU 201. The bus controller 204 has a bridge function with an external bus. The nonvolatile memory 205 is a memory whose content does not disappear even when the power is turned off. The disk controller 206 controls the storage 106. The flash disk 207 is an SSD or the like, and is a relatively small-capacity nonvolatile storage apparatus including a semiconductor device. The USB controller 208 controls USB equipment connected externally to the main system 200.

A USB memory 209, the operation unit 105, the storage 106, and the like are connected externally to the main system 200.

The sub-system 220 includes a relatively small general-purpose sub CPU system and image processing hardware.

The sub-system 220 includes a sub CPU 211, a memory 223, a bus controller 224, a nonvolatile memory 225, an image processing processor 226, a printer controller 227, and a scanner controller 228.

The sub CPU 211 controls the entire sub-system. The memory 223 is used as a work memory by the sub CPU 221. The bus controller 224 has a bridge function with an external bus. The nonvolatile memory 225 is a memory whose content does not disappear even when the power is turned off. The image processing processor 226 performs digital image processing in real time. The printer controller 227 and the scanner controller 228 are connected to the image processing processor 226. The printer controller 227 controls the printer apparatus 104 and passes digital image data to the printer apparatus. The scanner controller 228 controls the scanner apparatus 102 and receives digital image data from the scanner apparatus 102. The FAX apparatus 107 is directly controlled by the sub CPU 221.

Note that this FIG. 2 is merely a block diagram illustrated in a simplified manner. For example, the main CPU 201, the sub CPU 221, and the like include a large number of pieces of hardware around the CPU such as a chip set, a bus bridge, and a clock generator, which are unnecessary for the description of the embodiment and are thus described in a simplified manner. The block configuration illustrated in FIG. 2 does not limit the scope of the present invention.

Next, control processing by the controller 103 that is general will be described with image copy onto a sheet as an example.

When the user instructs copy of an image from the operation unit 105, the main CPU 201 sends an image reading command to the scanner apparatus 102 via the sub CPU 221. Due to this, the scanner apparatus 102 optically scans and reads a document, converts the document into digital image data corresponding to an image of the document, and inputs the digital image data to the image processing processor 227 via the scanner controller 228. The image processing processor 226 temporarily saves the digital image data in the memory 223 by DMA transfer.

Upon confirming that a certain amount or all of the digital image data are stored in the memory 223, the main CPU 201 issues an image output instruction to the printer apparatus 104 via the sub CPU 221. The sub CPU 221 notifies the image processing processor 226 of an address of the image data in the memory 223, and transmits the digital image data in the memory 223 to the printer apparatus 104 in accordance with a synchronization signal from the printer apparatus 104. At this time, the digital image data is transmitted to the printer apparatus 104 via the image processing processor 226 and the printer controller 227, and the printer apparatus 104 prints the digital image data onto a sheet.

When performing printing of a plurality of copies, the main CPU 201 saves, into the storage 106, the image data in the memory 223. In the second and subsequent copies, it is possible to output the digital image data read from the storage 106 and causes the printer apparatus 104 to print the digital image data without receiving the digital image data from the scanner apparatus 102.

In the system configuration described in FIGS. 1 and 2, functions to be implemented are determined in advance. Therefore, it is a system in which functions to be implemented are fixed or assumed to have only some variations if they can be changed. Therefore, the hardware configuration of the system and a controller module configuration for performing control have little change, and the software for controlling the controller is also fixed.

In the present description, such a system not being premised on being changed but having fixed functions is called a fixed configuration system.

### First Embodiment

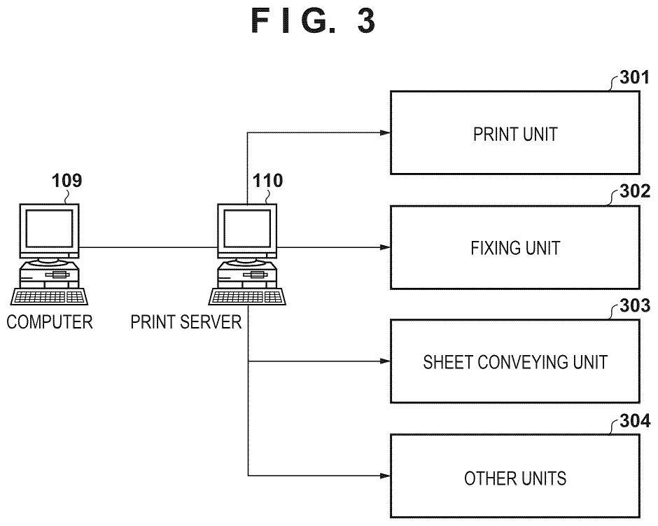

Next, in contrast to the fixed configuration system described above, a variable configuration system of the present embodiment will be described with reference to FIG. 3. Similarly to FIGS. 1 and 2, a printer system will be described as an example, but the variable configuration system of the present invention is not limited to the printer system.

As illustrated in FIG. 3, the printer system of the present embodiment is configured by connecting the computer 109 and a print server 110 via a LAN. The user can control the printer system using the computer 109. The print server 110 is connected to a print unit 301, a fixing unit 302, a sheet conveying unit 303, and other units 304, and controls these constituent units. Upon receiving an instruction from the user, the computer 109 transmits print job information to the print server 110. The print server 110 can temporarily save the received print job information, control each constituent unit, and execute a print job.

The print unit 301 forms a pattern with ink toner on a paper surface based on image data. The fixing unit 302 fixes, with heat, the pattern formed by the ink toner to the paper surface. The sheet conveying unit 303 takes out a sheet for printing from a sheet feed section, sequentially moves the sheet to a processing position of each device, and finally discharges the sheet to a sheet discharge section.

Furthermore, it is possible to execute the print job in cooperation with the other units 304. As described later, on this platform, the hardware of each unit can be arbitrarily replaced. The units constituting the print server 110 are not limited to them, and may include any other units. In the print system illustrated in FIG. 3, the units can be replaced in accordance with the configuration of the printer system, and the configuration of the print system can be changed. In the present description, a system in which the configuration of the system can be changed is called a variable configuration system in contrast to the fixed configuration system described above.

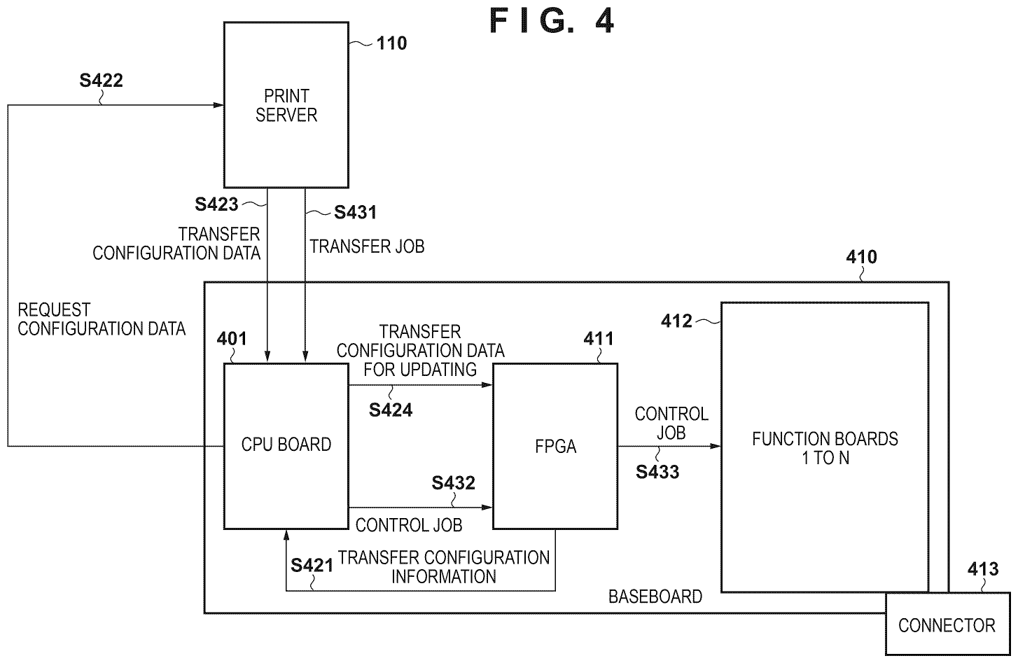

Next, the configuration of a unit controller of the variable configuration system in the present embodiment will be described with reference to FIG. 4. In FIG. 3, it is described that a print job is input from the computer 109 to the print server 110, and the print job is executed in each unit. The controller including a baseboard 410 illustrated in FIG. 4 corresponds to the controller of each unit in FIG. 3. The baseboard 410 of each unit has the same basic configuration although a function board 412 is different depending on the function to be provided.

The unit controller of each unit of the present embodiment includes a CPU board 401 and the baseboard 410. The CPU board 401 is a board mounted with a CPU.

Examples of the mounted CPU include, but are not limited to, CPUs provided by Intel (registered trademark), Arm (registered trademark), and the like.

The baseboard 410 is mounted with an FPGA 411, and the CPU board 401 is connected thereto. The baseboard 410 is provided with one or more slots into which the function board 412 can be inserted. The FPGA 411 can change the circuit structure by a program, and can configure an optimum circuit in accordance with the function of each unit. In the present embodiment, the FPGA 411 operates with different firmware corresponding to the respective functions of the print unit 301, the fixing unit 302, the sheet conveying unit 303, and the other units 304. The firmware of the FPGA 411 can be changed on site in accordance with the function of the unit.

Here, the structure and operation of the FPGA will be described. The FPGA includes a gate array and a configuration memory. In place of implementing a logic circuit by a transistor, the FPGA holds data (configuration data) of a truth table of a logic circuit in a configuration memory, and causes the data to practically serve as a gate of the logic circuit. Therefore, the FPGA can change the circuit configuration of the gate array of the FPGA by changing the configuration data. In general, loading configuration data into an FPGA is called configuration of the FPGA. Since the configuration data represents a circuit configuration of the FPGA, the configuration data can be called a program of the FPGA.

In general, an SRAM is used as a configuration memory of the FPGA. Since the SRAM is volatile, configuration data is stored in a flash memory, and the configuration data is loaded into the configuration memory of the FPGA when the power is turned on. The flash memory for storing configuration data is externally provided separately from the FPGA in general, but may be incorporated in the FPGA and configured as one chip.

There is also an FPGA in which the configuration memory is not configured by an SRAM but a flash memory. It has an advantage that the configuration memory can be booted at high speed because of lower power consumption than that when the configuration memory is configured with the SRAM and not requiring loading when the power is turned on. On the other hand, a manufacturing process unique to a flash cell is required, and therefore there is a disadvantage that the cost is high.

Since a system using the FPGA is mounted with the FPGA and rewritable firmware, there is a possibility that an error occurs in the FPGA and the firmware. There are two kinds of errors of the FPGA, a hardware error and a software error. In the case of the hardware error, the FPGA itself is damaged, and the error is reproduced even if the FPGA is rebooted. The hardware error may include a physical impact due to carelessness and destruction due to abnormality of the power supply.

Recent studies have found that an error occurs in a semiconductor element due to cosmic rays (neutrons) falling on the earth. Neutrons may accidentally hit the semiconductor element and invert the data saved as 0 and 1. Since the FPGA stores circuit information in the SRAM, when 0 and 1 in the circuit information of the SRAM are inverted, the circuit configuration changes, and therefore a normal operation cannot be performed. Such an error is called a software error, and in the case of the software error, recovery is often performed by reconfiguring the SRAM of the FPGA from the flash memory by rebooting or the like.

The description returns to FIG. 4. The function board 412, which is a small board, can be replaced with the baseboard 410. The units have different functions to be implemented. For example, since the fixing unit 302 needs to fix a pigment at a high temperature, it requires a component that generates heat. On the other hand, the sheet conveying unit 303 requires a motor for conveying paper. The function board 412 is mounted on the baseboard 410 in different types, numbers, and combinations in order to implement different functions for each unit. The function board 412 can be arbitrarily replaced in accordance with a change in hardware.

The baseboard 410 includes a connector 413. The connector 413 is for connecting to a unit case of each unit, and includes a plurality of pins. Due to the potential of each pin of the connector 413, it can be determined to which unit the baseboard 410 is connected.

The print server 110 receives a print job from the computer 109, and controls each unit based on the print job to execute printing. The print server 110 stores configuration data that is a firmware program of the FPGA 411. The firmware of the FPGA 411 can be updated by writing the configuration data into the configuration memory of the FPGA 411.

The unit controller of the variable configuration system in the present embodiment can handle functions of various units by replacement of the function board 412. It is difficult for the CPU board 401 to perform control corresponding to all types of the function boards 412. This is because the capacity of the nonvolatile memory on the CPU board is usually about several hundred MB, whereas the types and combinations of the function boards 412 are almost infinite. Therefore, a mechanism for providing a method for controlling to the CPU board is required in accordance with the combination of the function boards 412, and the FPGA 411 plays a role of the mechanism.

In the present embodiment, the CPU board 401 is configured to update the firmware of the FPGA 411 at the time of booting. The CPU board 401 can communicate with and control the function board 412 via the FPGA 411.

An execution operation of the print job in the unit controller will be described with reference to FIG. 4. Each sequence number included in FIG. 4 is indicated by a number starting with “S”. The print server 110 receives a print job from the computer 109 and transfers the received print job to the CPU board 401 (S431).

The CPU board 401 controls the print job for the FPGA 411 (S432). Specifically, the CPU board 401 transfers print information, the number of copies, color settings, and the like of the print job to the FPGA 411. Upon receiving an instruction from the CPU board 401, the FPGA 411 controls the function board 412 to execute the print job (S433).

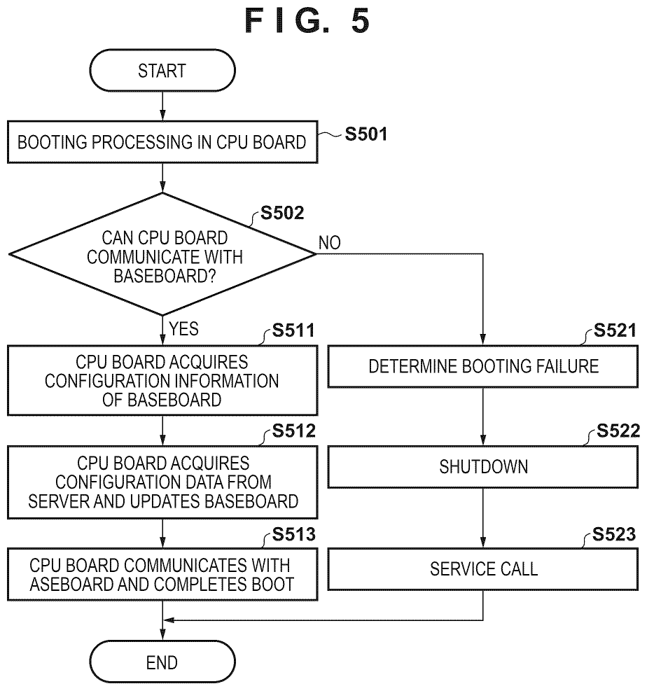

Update processing of the firmware of the FPGA at the time of booting of each unit will be described with reference to FIGS. 4 and 5. The processing described below is implemented, for example, by the CPU of the CPU board 401 reading, into the memory, and executing a program stored in the nonvolatile memory. Hereinafter, the step number of each process included in the flowchart is indicated by a number starting with “S”. The same applies to the subsequent flowcharts.

The process of FIG. 5 is started by booting the printer system. In S501, booting processing in the CPU board 401 of each unit controller is performed. The system is booted from a boot loader to boot an OS and apps. In the present embodiment, the baseboard 410 is mounted with a flash memory not illustrated, the flash memory functions as a configuration device, and configuration data for operating the FPGA 411 is stored. Together with booting, the configuration data stored in the flash memory is loaded into the SRAM, which is a configuration memory of the FPGA 411. Hereinafter, the description will be given on the premise of this configuration, but the configuration of the configuration device and the configuration memory is arbitrary. For example, the flash memory may be provided inside the FPGA 411, or the configuration memory itself may be configured by the flash memory.

In S502, it is determined whether the CPU board 401 can communicate with the FPGA 411 of the baseboard 410. In a case where the CPU board 401 can communicate with the baseboard 410 in S502 (YES), the process proceeds to S511, and in a case where the CPU board 401 cannot communicate with the baseboard 410 (NO), the process proceeds to S521. Here, the case where the CPU board 401 cannot communicate with the baseboard 410 includes, in addition to the case where communication itself is not possible, a state where communication is possible but some error has occurred and the operation is not normal, the state where the configuration information of the baseboard 410 in S511 cannot be acquired.

In S502, if YES, the CPU board 401 first establishes communication with the baseboard 410. Next, the FPGA 411 of the baseboard 410 acquires, from the connector 413, as to which unit the baseboard 410 itself is inserted into. The FPGA 411 acquires information such as the type and number of the function boards 412. Then, the FPGA 411 transfers, to the CPU board 401, the acquired unit information and the information on the function board 412 as configuration information of the baseboard 410 (S421).

In S511, the CPU board 401 acquires the configuration information of the baseboard 410 transferred from the FPGA 412. Then, the CPU board 401 requests the print server 110 for configuration data corresponding to the configuration information of the baseboard 410 (S422). This configuration data varies depending on the configuration of the unit, and is determined in accordance with the configuration information of the baseboard 410. The print server 110 transfers predetermined configuration data to the CPU board 401 based on the configuration information (S423).

In S512, the CPU board 401 stores the configuration data received from the print server 110 into the flash memory, which is a configuration device of the FPGA 411. The FPGA 411 reboots and writes the updated configuration data into the configuration memory. This enables the FPGA 411 to control the unit based on the latest configuration changed from the time of the previous shutdown. In S513, the CPU board 401 communicates with the baseboard 410 and completes the system booting processing.

In this manner, in the present embodiment, since the unit controller can detect a change in hardware at the time of booting, the firmware of the FPGA 411 is changed with the change in hardware. Therefore, the print system including the unit controller of the present embodiment is a variable configuration system. In FIG. 5, the flow is started by the booting of the CPU board 401, but the processing of S511 to S515 may be performed when an error in the configuration data is detected by an error correction code.

The operation in which the variable configuration system executes the print job and the operation when booting is normal have been described above. Next, an operation when an error occurs at the time of booting will be described with reference to FIG. 5. In S502, in the case where the CPU board 401 cannot communicate with the baseboard 410 (NO), the process proceeds to S521, and the operations in and after S521 are the operation in the case of an error.

The case where the CPU board 401 cannot communicate with the baseboard 410 includes, as described above, a state where the operation is not normal, and the configuration information of the baseboard 410 in S511 cannot be acquired.

In S521, a booting failure of the unit controller is determined. When the communication with the FPGA 411 is not normal, it is determined that the booting is impossible, and shutdown of the printing system is performed in S522. In S523, a service call to a call center is made. Thereafter, a service engineer is dispatched from the call center to perform recovery work.

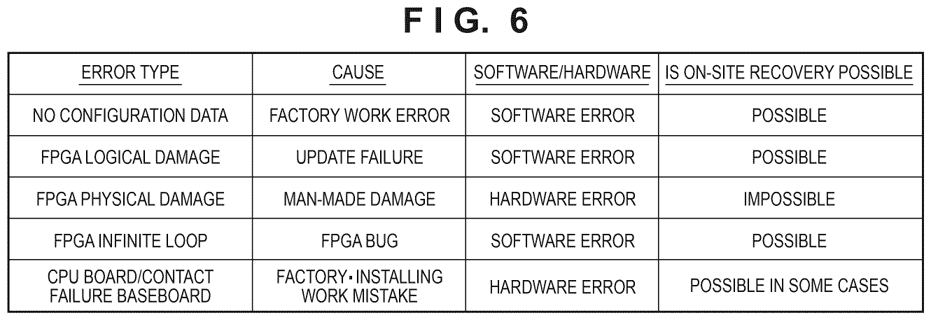

With reference to FIG. 6, cases of errors that can occur in the variable configuration system will be described. The cases given here are merely for explanation, and are not limited to the cases given here in an actual environment. The errors listed in FIG. 6 are assumed to occur at a factory, on site, or the like. These errors may be classified into hardware errors and software errors. Moreover, there are cases where recovery can be performed on site, cases where recovery cannot be performed, or cases where recovery can be performed in some cases.

First, if no firmware is written to the configuration device of the FPGA 411, the FPGA 411 cannot be booted. Such a case is a software error, and considered to be caused by a work error in a factory or on site. Because it is solved by writing firmware into the flash memory, on-site recovery is possible.

Next, a case where there is a logical error in the firmware of the FPGA 411 is a software error and considered to be caused a failure in update. This is considered to be caused by an error when the configuration data is written to the flash memory or an error when the configuration data is written to the SRAM of the FPGA 411. Such an error can be recovered on site by rewriting or rebooting of the configuration data to the flash memory.

A case where the FPGA 411 is physically damaged is a hardware error and considered to be man-caused damage or damage to an electrical circuit due to a power supply abnormality. Since it is necessary to replace the FPGA 411 or replace the baseboard 410 itself, it is impossible to perform recovery on site.

Next, a case where the firmware of the FPGA 411 performs an infinite loop operation is a software error and considered to be caused by a bug in the firmware. By updating the flash memory with correct firmware (configuration data) and rebooting, on-site recovery is possible.

Next, a case of a contact failure between the CPU board 401 and the baseboard 410 is a hardware error and considered to be caused by an error in factory or site installation work. In this case, whether or not on-site recovery is possible is determined depending on whether or not the on-site user is capable of handling.

In the booting processing illustrated in FIG. 5, whatever case an error of the FPGA illustrated in FIG. 6 occurs is determined to be a booting failure, shutdown is performed, and a service call to the call center is made. On the other hand, as illustrated in FIG. 6, depending on the type of error, recovery is possible on site, and if recovery is possible on site, it is not necessary for the service engineer to go from the call center, which leads to cost reduction.

Next, processing of determining whether recovery is possible on site, performing recovery on site when recovery is possible on site, and making a service call to the call center only when recovery is not possible on site will be described. The processing described below is implemented, for example, by the CPU of the CPU board 401 reading, into the memory, and executing a program stored in the nonvolatile memory.

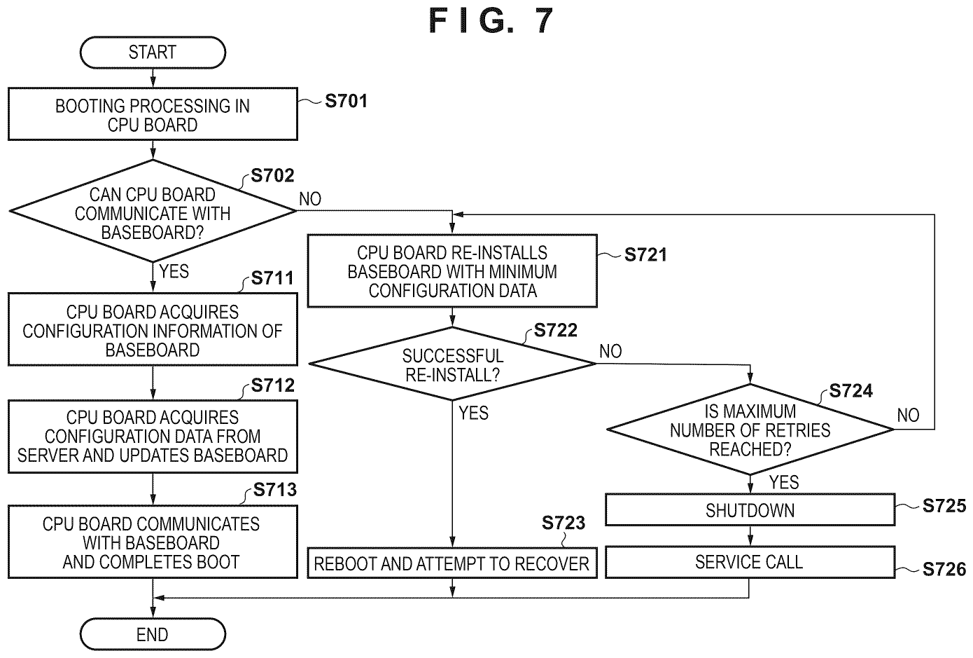

With reference to FIG. 7, processing of performing recovery on site using the minimum configuration data built in the CPU board 401 will be described.

The processing of FIG. 7 is started by booting the printer system. In S701, booting processing in the CPU board 401 of each unit controller is performed. In S702, it is determined whether the CPU board 401 can communicate with the FPGA 411 of the baseboard 410. In S702, if communication with the FPGA 411 of the baseboard 410 is possible (YES), the process proceeds to S711, and the CPU board 401 establishes communication with the baseboard 410. On the other hand, if communication is not possible (NO), the process proceeds to S721. The case where communication is not possible includes a state where the operation is not normal and the configuration information of the baseboard 410 in S711 cannot be acquired.

Since the processing of S711 to S713 is the same as the processing of S511 to S513 of FIG. 5, the description will be omitted. In FIG. 7, the flow is started by the booting of the CPU board 401, but the processing of S711 to S715 may be performed when an error in the configuration data is detected by an error correction code.

When it is determined that the CPU board 401 cannot communicate with the baseboard 410, the process proceeds to S721. The CPU of the CPU board 401 writes built-in minimum configuration data described later into the configuration device of the FPGA 411. Due to this, the minimum configuration data is reinstalled in the FPGA 411 of the baseboard 410. The processing in and after S721 may be performed when an error in the configuration data is detected by an error correction code.

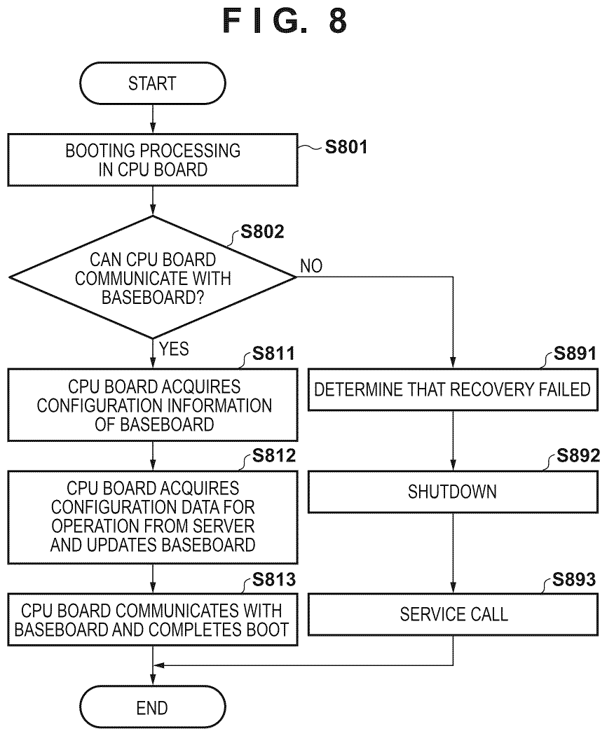

If it is determined in S722 that the reinstallation of the minimum configuration data has succeeded (YES), the process proceeds to S723. In S723, the FPGA 411 attempts rebooting by writing the reinstalled minimum configuration data into the SRAM. The recovery process by the rebooting will be described later with reference to FIG. 8.

If it is determined in S722 that the reinstallation of the firmware has failed (NO), the process proceeds to S724, and the reinstallation of S721 and S722 is retried and repeated until the maximum number of retries is reached. In S724, if the reinstallation of the firmware is not successful even when the maximum number of retries is reached, the process proceeds to S725. The printer system is shut down in S725, and a service call is made to the call center in S726. Thereafter, a service engineer is dispatched from the call center to perform recovery work.

The processing of S723 in FIG. 7 will be described in detail with reference to FIG. 8. The processing illustrated in FIG. 8 is a recovery process in a case where the CPU board 401 fails to communicate with the FPGA 411 of the baseboard 410 during booting but the reinstallation of the firmware succeeds thereafter.

In S801, the CPU board 401 performs boot processing. Here, in S801, rebooting of the CPU board 401 is not always necessary, and only rebooting of the FPGA 411 of the baseboard 410 may be performed. The FPGA 411 attempts rebooting by writing the reinstalled minimum configuration data to the SRAM.

In S802, it is determined whether the CPU board 401 can communicate with the FPGA 411 of the baseboard 410. If it is determined that the communication is not possible (NO), the process proceeds to S821, and a recovery failure is determined. This is because it is determined that recovery on site is impossible since recovery is not possible even by the reinstallation of the firmware. Then, the process proceeds to S822 to perform shutdown of the printer system, and in S823, a service call to the call center is made. Thereafter, a service engineer is dispatched from the call center to perform recovery work.

On the other hand, in S801, the FPGA 411 performs rebooting by writing the minimum configuration data stored into the flash memory into the SRAM, and the process proceeds to S802. If communication with the CPU board 401 is possible (YES), the process proceeds to S811. In S811, the CPU board 401 first establishes communication with the baseboard 410.

Then, the CPU board 401 acquires the configuration information of the baseboard 410 from the FPGA 411 of the baseboard 410. As described above, the configuration information of the baseboard 410 can be acquired by the FPGA 411 acquiring the information of the connector 413 and the information of the function board 412 and transferring the information to the CPU board 401.

Then, in S812, the CPU board 401 acquires the configuration data from the print server 110 based on the configuration information of the baseboard 410. This configuration data is the same as that acquired in S512 of FIGS. 5 and S712 of FIG. 7, and is different from the minimum configuration data. Details of both will be described later.

The CPU board 401 writes the acquired configuration data into the flash memory of the baseboard 410. The FPGA 411 writes, into the SRAM, the configuration data written in the flash memory and reboots the SRAM.

Due to this, the FPGA 411 of the baseboard 410 operates with the updated configuration data. In S813, the CPU board 401 communicates with the baseboard 410 and completes booting.

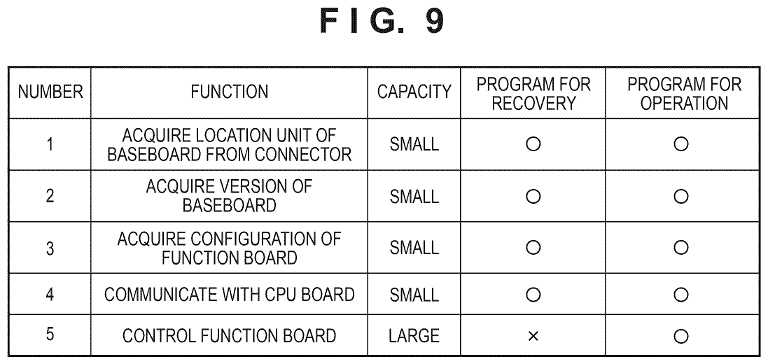

The minimum configuration data and the configuration data will be described with reference to FIG. 9. The configurations of the minimum configuration data and the configuration data illustrated in FIG. 9 are examples, and do not limit implementation in an actual system. The minimum configuration data is an example of a recovery program in the present invention, and the configuration data is an example of an operation program in the present invention. The operation of the FPGA 411 by the configuration data is called a normal operation, and the operation of the FPGA 411 by the minimum configuration data is called a recovery operation.

The operation program has all the functions illustrated in FIG. 9. In the normal operation, a value of each pin of the connector 413 of the baseboard 410 is acquired, and which unit the baseboard 410 itself is mounted to is acquired. In the normal operation, the version of the baseboard 410 is acquired. This is because there may be a modification depending on the version of the baseboard 410 and thus the operation can change. In the normal operation, configuration information such as the configuration (type and number) of the function board 412 is acquired. These pieces of configuration information are information necessary for acquiring configuration data for controlling the function board 412. In the normal operation, the FPGA 411 communicates with the CPU board 401 and transfers the acquired configuration information to the CPU board 401. The CPU board 401 acquires predetermined configuration data from the print server 110 based on the configuration information, and updates the flash memory with the acquired configuration data. Due to this, the FPGA 411 performs rebooting based on the updated configuration data. After the booting is completed, the FPGA 411 controls the function board 412 while exchanging with the CPU board 401, and executes the print job.

The recovery program has a function of acquiring information of a unit mounted with the baseboard 410, a function of acquiring version information of the baseboard 410, and a function of acquiring the configuration information of the function board 412. It also has a function of communicating with the CPU board 401. On the other hand, it does not have a function of controlling the function board 412. This is because, as described above, since the types and combinations of the function boards 412 are almost infinite, the size is too large to be stored in the nonvolatile memory of the CPU board 401. Therefore, in order to store the minimum configuration data into the nonvolatile memory of the CPU board 401, the control function of the function board 412 is omitted, and the capacity is limited to a certain amount or less.

Hereinafter, other embodiments of the present invention will be described.

### Second Embodiment

The CPU board 401 communicates with the baseboard 410 at the time of booting, and determines the corresponding configuration data from a location unit and version of the baseboard 410 and the configuration information of the function board 412. Then, it is compared with the configuration data of the FPGA 411 of the baseboard 410, and if the both are the same version, it is not necessary to update the configuration data.

### Third Embodiment

Depending on the location unit (environment where it is placed, for example, whether to be a print unit or a fixing unit), the baseboard 410 may require different minimum configuration data. In that case, it is necessary to store a plurality of types of minimum configuration data in the CPU board 401. Then, it is possible to transfer the minimum configuration data to the flash memory of the baseboard 410 one by one or collectively transfer them to the flash memory and cause the CPU board 401 to determine which minimum configuration data to use at the time of rebooting.

### Fourth Embodiment

It is assumed that a plurality of phenomenon patterns occur during a recovery process. A handling method varies depending on what kind of phenomenon occurs.

If the minimum configuration data cannot be written, it is determined to be highly possible to be an error caused by hardware damage. Since there is a possibility that the FPGA 411 itself is damaged, the service engineer can prepare components in advance.

If the minimum configuration data can be reinstalled but the configuration data cannot be reinstalled, it cannot be determined whether it is a software error or a hardware error. This case requires a determination by the service engineer.

When the CPU board 401 can or cannot recover the baseboard 410 after trying to recover the baseboard 410 a plurality of times, it is considered to be a contact failure between the CPU board 401 and the baseboard 410 or the like. In this case, the service engineer can narrow down the cause of the occurrence of the error by information on the type of the phenomenon.

When both the minimum configuration data and the configuration data can be written to the flash memory and the FPGA 411 can be rebooted, it can be simply determined as a software error. In this case, since it is possible to recover on site, it is not necessary to dispatch the service engineer.

As described above, it is possible to collect information that serves as a reference of the handling method depending on the phenomenon pattern occurring in the recovery process. By reporting, to the call center, information on a phenomenon occurred in the recovery process, the factor of the occurrence of the problem can be narrowed down, which leads to a reduction in response time and cost when the service engineer is dispatched.

According to the information processing apparatus of the present embodiment, it is possible to handle verification and recovery of a wide variety of firmware of the FPGA by recovering the firmware of the FPGA by the minimum configuration data having the minimum function of the firmware of the FPGA. According to the verification of the present embodiment, it is possible to select an appropriate recovery method for the cause of the error and determine whether to make a service call.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-004657, filed Jan. 16, 2024 filed, which is hereby incorporated by reference herein in its entirety.

What is claimed is:

1. An information processing apparatus including one or more units, wherein
the one or more units include a unit controller,
the unit controller includes a first sub-system and a second sub-system, and
in a case where the first sub-system cannot communicate with the second sub-system when the information processing apparatus is booted, the first sub-system overwrites, with a recovery program, a program of the second sub-system stored in a memory in which the program of the second sub-system is stored.

2. The information processing apparatus according to claim 1, wherein
the first sub-system includes a CPU, and the second sub-system includes an FPGA.

3. The information processing apparatus according to claim 1, wherein
the recovery program is stored in the first sub-system.

4. The information processing apparatus according to claim 1, wherein
when the first sub-system and the second sub-system establish communication, the second sub-system collects configuration information of the second sub-system and transfers the configuration information to the first sub-system, and
the first sub-system acquires an operation program based on the configuration information from a server, and updates the program of the second sub-system with the operation program.

5. The information processing apparatus according to claim 4, wherein
the operation program varies depending on a configuration of the second sub-system.

6. The information processing apparatus according to claim 4, wherein
when the recovery program fails in recovery or the operation program fails in recovery, the first sub-system calls a call center regarding failure in on-site recovery.

7. The information processing apparatus according to claim 4, wherein
the recovery program is a program in which some functions are removed from the operation program.

8. The information processing apparatus according to claim 7, wherein
the some functions that are removed are control functions of a device.

9. The information processing apparatus according to claim 4, wherein
the recovery program has a function of performing boot control of the second sub-system, a function of acquiring configuration information of the second sub-system, and a function of performing communication with the first sub-system.

10. An information processing apparatus including one or more units, wherein
the one or more units include a unit controller,
the unit controller includes a first sub-system and a second sub-system,
when the information processing apparatus is booted, the second sub-system collects configuration information of the second sub-system and transfers the configuration information to the first sub-system, and
the first sub-system acquires a program based on the configuration information from a server, and overwrites, with the program, a program of the second sub-system stored in a memory in which the program of the second sub-system is stored.

11. A method for controlling an information processing apparatus including one or more units each including a unit controller including a first sub-system and a second sub-system, wherein
in a case where the first sub-system cannot communicate with the second sub-system when the information processing apparatus is booted, the first sub-system overwrites, with a recovery program, a program of the second sub-system stored in a memory in which the program of the second sub-system is stored.

12. A non-transitory computer-readable storage medium, the storage medium storing a program for causing a computer to execute each step of a method for controlling an information processing apparatus including one or more units each including a unit controller including a first sub-system and a second sub-system, the method wherein
in a case where the first sub-system cannot communicate with the second sub-system when the information processing apparatus is booted, the first sub-system overwrites, with a recovery program, a program of the second sub-system stored in a memory in which the program of the second sub-system is stored.
